(19) United States
(12) Patent Application Publication
(10) Pub. No.: US 2013/0015023 A1
(43) Pub. Date: Jan. 17, 2013

(54) Heat Pipe Cooled Brake System

(71) Applicants: Timothy Hassett, Santa Rosa, CA (US); Mark Hodowanec, Murrysville, PA (US)

(72) Inventors: Timothy Hassett, Santa Rosa, CA (US); Mark Hodowanec, Murrysville, PA (US)

(73) Assignee: HPEV, INC., Wesley Chapel, FL (US)

(21) Appl. No.: 13/547,203

(22) Filed: Jul. 12, 2012

Related U.S. Application Data
(60) Provisional application No. 61/507,219, filed on Jul. 13, 2011.

(51) Int. Cl. F16D 65/847; F16D 55/22

(52) U.S. Cl. 188/71.6

(57) ABSTRACT

The present disclosure provide various systems and methods for cooling mobile platform braking systems, e.g., braking systems for automobiles, aircraft, motorcycles, etc., utilizing heat pipes. The heat pipes are disposed within components of the braking systems, e.g., brake rotors, calipers and brake pads, to efficiently remove large amounts of heat from such components that is generated during use of the respective braking system to slow and/or stop movement of the respective mobile platform.

### CROSS-REFERENCE TO RELATED APPLICATIONS

This application claims the benefit of U.S. Provisional Application No. 61/507,219, filed on Jul. 13, 2011. The disclosures of the above application is incorporated herein by reference in its entirety.

### FIELD

The present teachings relate to braking systems for mobile platforms, and more particularly to systems and methods for cooling mobile platform braking systems via heat pipes.

### BACKGROUND

The statements in this section merely provide background information related to the present disclosure and may not constitute prior art.

The braking systems, also referred to herein simply as brakes, for many mobile platforms, e.g., automobiles, aircraft, motorcycles, etc., use friction to convert kinetic energy to heat. Heat is a necessary by product of how brakes work. However, these areas are all temperature limited. For example, in contemporary disc brake systems there are generally three key components that are subject to heat generated by use of the braking system: 1) the brake rotors; 2) the brake calipers; and 3) the brake pads, all of which are subject to large amounts of heat during use.

This is significant as the total amount of braking provided by the respective braking system is proportional to the total amount of heat produced. Hence, removing/dissipating the heat from such components is important to the efficiency, capability and reliability of the respective braking system. Known braking systems rely on direct contact with the heated components by air flowing around the components to remove/dissipate the heat. This method of cooling or heat removal/dissipation is highly inefficient and limits the useful life of such components. For example, traditional braking system rotors are internally finned to help to pump air thru them, however they are still extremely limited in their ability to shed heat as the air flow inside the wheel is limited. Additionally, although the rotors can be manufactured to tolerate the extremely high temperatures, the surrounding components (namely the calipers) cannot.

Particularly, the calipers of the braking system can tolerate the least amount of heat and are most subject to failure due to the heat generated by operation of the braking system. If the brake caliper gets too hot, there is an increased possibility that the brake fluid will boil, which results in an inability for the caliper to exert proper pressure on the brake pads. This in turn reduces the ability of the brakes to slow and/or stop the respective mobile platform. Furthermore, with excessive heat the piston could stick within the caliper, or rubber seals can fail.

### SUMMARY

The present disclosure provide various systems and methods for cooling mobile platform braking systems, e.g., braking systems for automobiles, aircraft, motorcycles, etc., utilizing heat pipes. The heat pipes are disposed within components of the braking systems, e.g., brake rotors, calipers and brake pads, to efficiently remove large amounts of heat from such components that is generated during use of the respective braking system to slow and/or stop movement of the respective mobile platform.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a cross-sectional view of a heat pipe cooled brake system, in accordance with various embodiments of the present disclosure.

FIG. 2A is a cross-sectional view of a heat pipe cooled rotor of the system shown in FIG. 1, in accordance with various embodiments of the present disclosure.

FIG. 2B is another cross-sectional view of the heat pipe cooled rotor of the system shown in FIG. 1, in accordance with various embodiments of the present disclosure.

FIG. 3 is a cross-sectional view of a heat pipe cooled caliper of the system shown in FIG. 1, in accordance with various embodiments of the present disclosure.

FIG. 4 is a cross-sectional view of a heat pipe cooled brake pad assembly of the system shown in FIG. 1, in accordance with various embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements.

By removing heat from the various components of braking systems to areas that can better shed/dissipate the heat (such as heat sinks, heat exchangers, etc.) the total amount of heat that can be removed is increased. In order to move large amounts of heat through relatively small areas and small differences in temperature, heat pipes can be used to facilitate the necessary heat transfer.

As all the various embodiments of the present systems and methods for cooling mobile platform braking systems described herein are based on heat pipes, all of the various embodiments are passive in nature.

Generally, heat pipes are a heat transfer mechanism that can transport large quantities of heat with a very small difference in temperature between hot and cold interfaces. A typical heat pipe consists of a sealed hollow tube made of a thermally conductive material, e.g., a thermally conductive metal such as copper or aluminum. The heat pipe contains a relatively small quantity of a “working fluid” (such as water, ethanol or mercury) with the remainder of the heat pipe being filled with a vapor phase of the working fluid, all other gases being substantially excluded. Heat is transferred from an evaporator end of a heat pipe to an opposing condenser end of the heat pipe by a rapid heat vaporization of the working fluid from the evaporator end to the condenser end.

More particularly, heating the evaporator end of the heat pipe will cause the working fluid inside the heat pipe at the evaporator end to turn to vapor, thereby increasing the vapor pressure inside the heat pipe. Latent heat of evaporation absorbed by the vaporization of the working fluid reduces the temperature at the evaporator end of the heat pipe. Moreover, the vapor pressure at the evaporator end of the heat pipe is higher than the equilibrium vapor pressure at the condenser end of the heat pipe. This pressure difference drives a rapid mass transfer of the heated vaporized working fluid from the evaporator end to the condenser end of the heat pipe where the vapor condenses back to a fluid state, thereby releasing its latent heat and heating the condenser end of the heat pipe. The condensed working fluid then flows back to the evaporator end of the heat pipe.

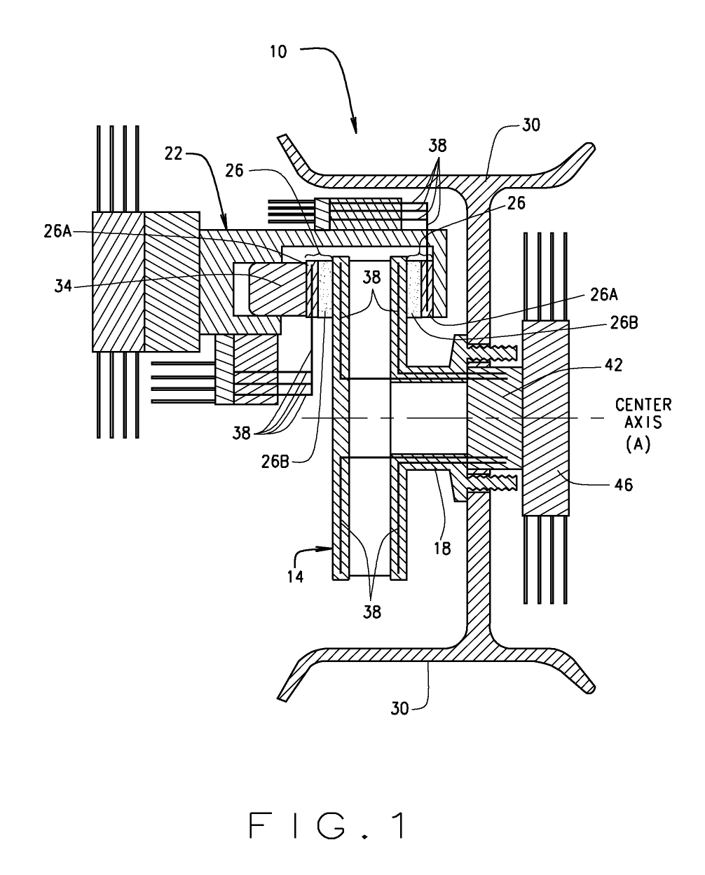

Referring now to FIG. 1, the present disclosure provides a heat pipe cooled (HPC) braking system 10. A mobile platform, e.g., automobile, aircraft, motorcycle, etc. can include the HPC braking system 10 disposed within the structure of each suspension and wheel assembly of the respective mobile platform. The HPC braking system 10 disposed within the structure of each suspension and wheel assembly of the respective mobile platform is substantially identical, therefore, only a single HPC braking system 10 will be described herein.

The HPC braking system 10 generally includes a rotor 14 mountable to a rotating wheel hub 18 of the respective suspension and wheel assembly, a caliper assembly 22 mountable to a stationarily portion of the suspension and wheel assembly, and a pair of brake pads 26 moveably disposed with caliper 22. Each brake pad 26 includes a metal backing 26A and a friction pad 26B. A wheel 30 of the mobile platform is mounted to the rotating hub 18 such that the rotor 14 and wheel 30 are operably interconnected and rotate simultaneously, at the same rate of speed, as a single subassembly. The caliper assembly 22 includes at least one piston 34, e.g., two opposing pistons 34, that is/are structured and operable to expand to apply force to the brake pads 26, as controlled by an operator of the mobile platform. Subsequently, the brake pads 26 are pushed against the rotor 14 to apply frictional force to the rotating rotor 14 to slow and/or stop rotation rotor 14 and the wheel 30 and hence the mobile platform. The HPC braking system 10 additionally includes a plurality of heat pipes 38 disposed within the rotor 14, and/or the caliper 22, and/or a metal backing 26A of the brake pads 26.

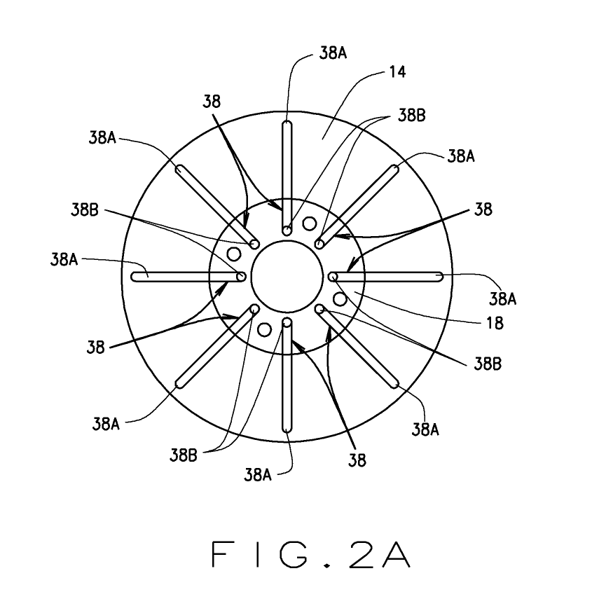

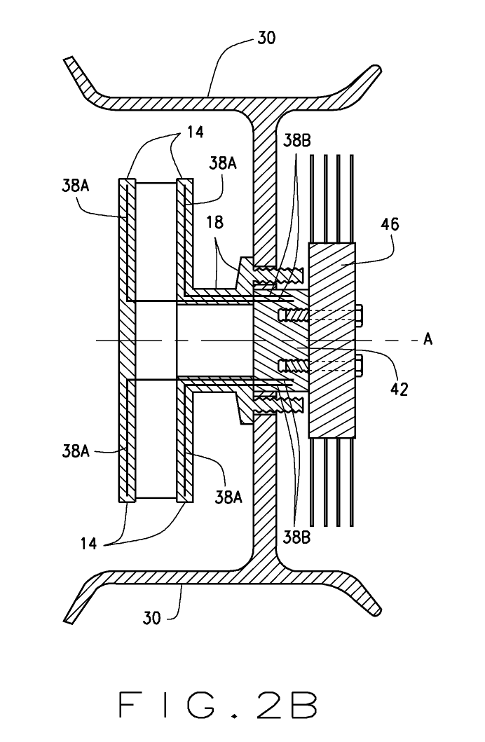

Referring now to FIGS. 2A and 2B, in various embodiments, heat pipes 38 can be disposed in the rotors 14 of a mobile platform braking system to assist in the cooling of the rotors 14 and thereby increase the efficiency, capability and reliability of the braking system. Particularly, the rotors 14 of a mobile platform braking system can get extremely hot during application of the brake pads 26 (FIG. 1) to rotors 14. The evaporator ends 38A of the heat pipes 38 (the hot end, the end of the heat pipe that absorbs the heat) is disposed at the outside diameter of the rotor 14, i.e., the same area where the brake pads 26 contact the rotor 14. The condenser ends 38B of the heat pipes 38 (the cool end, the end mounted to the heat exchanger) is disposed closer to the center of the rotor 14. In various embodiments, the condenser ends 38B extend through the center of the rotor 14, through the hub 18 and are disposed within a heat sink 42 (referred to herein as the rotor heat sink 42) that extends through a center aperture in the respective wheel 30 such that the rotor heat sink 42 is exposed at an exterior side of the wheel 30. In various embodiments, a finned heat exchanger 46 (referred to herein as the rotor heat exchanger 46) can be integrated with, i.e., thermally connected to, the rotor heat sink 42 and is disposed on the exterior side of the wheel 30. The rotor heat exchanger 46 can be thermally connected to the rotor heat sink 42, via one or more bolts.

In operation, the heat is carried from the rotor 14 to the rotor heat sink 42 via the heat pipes 38. Heat is transferred, via conduction, from the rotor 14 to the evaporator ends 38A of the heat pipes 38, then to the condenser ends 38B of the heat pipes 38, then, via conduction, to the rotor heat sink 42 permanently affixed to the condenser ends 38B, and then, via conduction, to the rotor heat exchanger 46 directly connected, i.e., thermally connected, to the rotor heat sink 42. In various implementations a thermal paste, e.g., thermal grease, can be applied between the rotor heat sink 42 and the rotor heat exchanger 46. The heat is finally removed, i.e., dissipated, via the finned rotor heat exchanger 46. The rotor heat exchanger 46 is disposed outboard, i.e., exteriorly, of the wheel 30, and fully exposed to the air flow.

Additionally, when configured as described above, circulation of the working fluid within the heat pipes 38, i.e., circulation between the vapor state of the working fluid at the evaporator ends 38A and the liquid state of the working fluid at the condenser ends 38B is enhanced due to centrifugal force generated by rotation of the wheel 30 and rotor 14. Particularly, the heat pipe working fluid is evaporated at the evaporator ends 38A disposed at the radially outward portion of the rotor 14. When the fluid evaporates, it moves radially inward to a radially inward to portion of the rotor 14 where the heat pipe condenser ends 38B are attached to, or disposed within, the rotor heat sink 42. When the rotor heat exchanger 46 cools the rotor heat sink 42 and thus the working fluid, the working fluid condenses from a gas back to a liquid. Then, centrifugal force via wheel 30 rotation helps to push the fluid back to the evaporator ends 38A of the heat pipes 38 where it can be evaporated again.

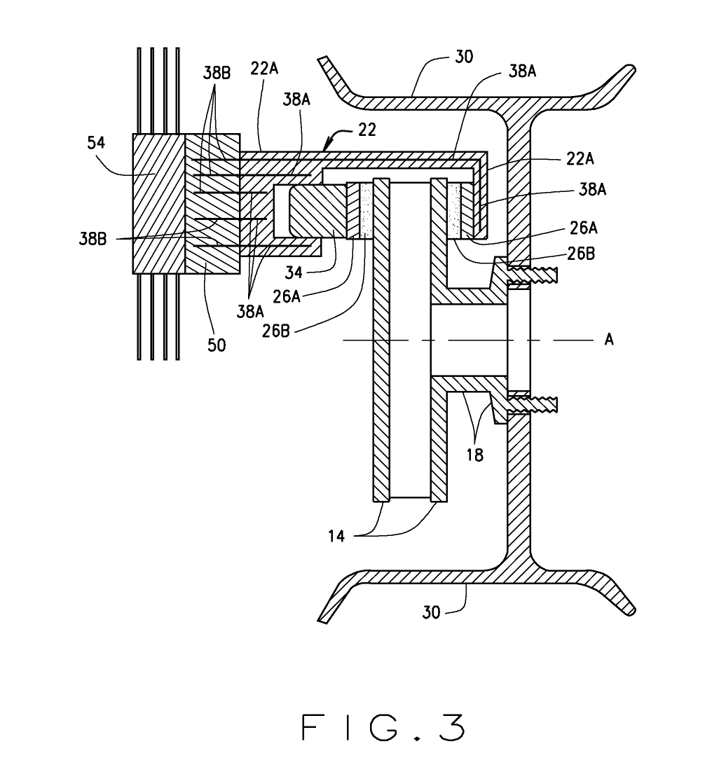

Referring now to FIG. 3, in various embodiments, heat pipes 38 can be disposed within the body 22A of the caliper 22 to assist in cooling the caliper 22 and reducing the risk of failure thereof. Additionally, by having heat pipes 38 disposed within the caliper body 22A, the caliper 22 and can be cooled, thereby reducing the amount of the heating of brake fluid used to operate the piston(s) 34. This will minimize chances of the brake fluid boiling and any potential for the caliper piston(s) 34 to seize.

Particularly, the evaporator ends 38A of the heat pipes 38 are disposed within various portions of the caliper body 22A. The condenser ends 38B are is disposed with a heat sink 50 (referred to herein as the caliper heat sink 50). In various implementations, the caliper heat sink can be mounted to the caliper body 22A. In various embodiments, a finned heat exchanger 54 (referred to herein as the caliper heat exchanger 54) can be attached to the caliper heat sink 50 to assisting in the cooling of the caliper heat sink 50 and hence, the cooling of the heat pipe condenser ends 38B, and hence the cooling of the caliper body 22A. Particularly, air flowing past the finned caliper heat exchanger 54 removes heat from the caliper heat exchanger 54, which in turn will removes heat from the caliper heat sink 50, which ultimately removes heat from the caliper body 22A.

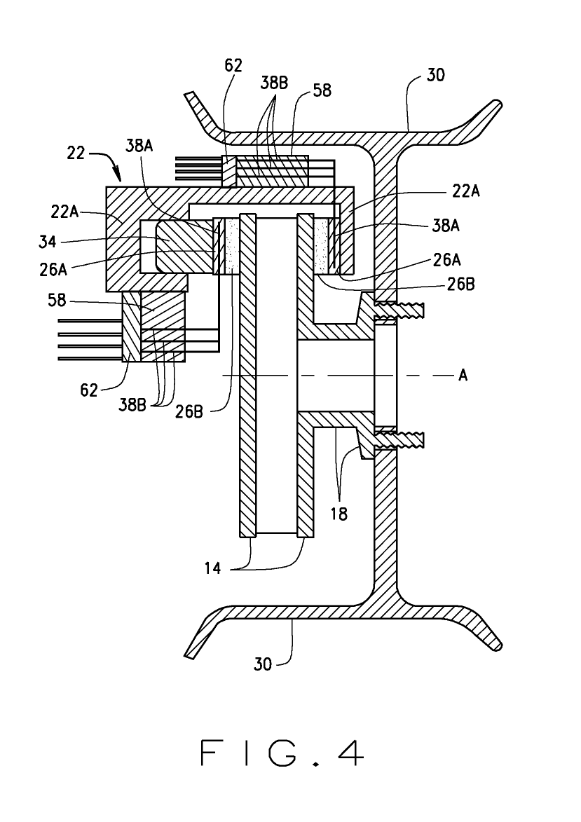

Referring now to FIG. 4, in various embodiments, the evaporator ends 38A of heat pipes can be disposed with the metal backing plate 26A of at least one of the brake pads 26. As described above, the brake pads 26 include the friction pads 26B mounted to metal back plates 26A. The condenser ends 38B of the heat pipes 38 are disposed within one or more heat sinks 58 (referred to herein as brake pad heat sink(s) 58). In various embodiments, one or more heat exchangers 62 (referred to herein as brake pad heat exchanger(s) 62) can be thermally connected to the brake pad heat sink(s) 58. Hence, heat from the friction pad(s) 26B is transferred to the metal backing plate(s) 26A and then to the brake pad heat sink(s) 58, via the heat pipes 38. Subsequently, the heat from the brake pad heat sink(s) 58 can be dissipated into the air via the brake pad heat exchanger(s) 62. Hence, heat can be efficiently removed from the brake pad(s) 26, particularly from the friction pad(s) 26B via the heat pipes 38. By removing heat from the friction pad(s) 26B, the life of the friction pad(s) 26B can be extended. Additionally, the amount of heat transferred from the brake pad(s) 26, i.e., the friction pad(s) 26B and backing plate(s) 26A, to the caliper 22 is reduced.

In various embodiments, addition to the condenser ends 38B of the heat pipes 38 being disposed with the stationary caliper and brake pad heat sinks 50 and 58, thermally conductive bonding straps (not shown) can be implemented to thermally connect major massive structural components of the respective mobile platform (e.g., the frame of a car) to the stationary caliper and brake pad heat sinks 50 and 58. Accordingly, such major massive structural components can act as additional heat sinks and heat exchangers to increase the removal of heat from the caliper and brake pad heat sinks 50 and 58, and hence from the braking system components. This will increase the overall cooling ability of the heat pipe brake system described herein.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A braking system for a mobile platform, said system comprising:
a rotor that is mountable to a wheel hub of a mobile platform;
a caliper assembly mountable to a stationary portion of the mobile platform, the caliper assembly including to one or more pistons;
a pair of brake pads, at least one of the brake pads interoperable with the one or more pistons to controllably apply frictional force to the rotor; and
a plurality of heat pipes structured and operable to remove heat from the at least one of the rotor, the caliper and the brake pads.

2. The system of claim 1, wherein the heat pipes comprise evaporator ends disposed within the rotor and condenser ends disposed within a rotor heat sink disposed within a center aperture of the wheel hub.

3. The system of claim 2 further comprising a rotor heat exchanger thermally connected to the rotor heat sink.

4. The system of claim 1, wherein the heat pipes comprise evaporator ends disposed within the caliper and condenser ends disposed within a caliper heat sink.

5. The system of claim 4 further comprising a caliper heat exchanger thermally connected to the caliper heat sink.

6. The system of claim 1, wherein the heat pipes comprise evaporator ends disposed within at least one of the brake pads and condenser ends disposed within at least one brake pad heat sink.

7. The system of claim 6 further comprising at least one brake pad heat exchanger thermally connected to the at least one brake pad heat sink.

8. The system of claim 1, wherein the heat pipes comprise:
evaporator ends disposed within at least two of the rotor, the caliper and one or more of the brake pads; and
condenser ends disposed within a respective two or more of a rotor heat sink, a caliper heat sink and one or more brake pad heat sinks.

9. A braking system for a mobile platform, said system comprising:
a rotor that is mountable to a wheel hub of a mobile platform;
a caliper assembly mountable to a stationary portion of the mobile platform, the caliper assembly including to one or more pistons;
a pair of brake pads, at least one of the brake pads interoperable with the one or more pistons to controllably apply frictional force to the rotor; and
a plurality of heat pipes having evaporator ends disposed within at least one of the rotor, the caliper and at least one the brake pads for removing heat from the at least one of the rotor, the caliper and the at least one brake pads.

10. The system of claim 9, wherein the heat pipes further comprise condenser ends disposed within at least one of a respective rotor heat sink, a caliper heat sink and at least one brake pad heat sink.

11. The system of claim 10 further comprising a rotor heat exchanger thermally connected to the rotor heat sink.

12. The system of claim 10 further comprising a caliper heat exchanger thermally connected to the caliper heat sink.

13. The system of claim 10 further comprising at least one brake pad heat exchanger thermally connected to the at least one brake pad heat sink.

14. A method for dissipating heat from braking system for a mobile platform, said method comprising:
disposing a plurality of heat pipes within at least one of a rotor, a caliper and at least one a pair of brake pads of a mobile platform braking system such that heat is removed from the at least one of the rotor, the caliper and the at least one brake pad, wherein:
the rotor is mountable to a wheel hub of a mobile platform;
the caliper assembly is mountable to a stationary portion of the mobile platform and includes to one or more pistons; and
at least one of the brake pads is interoperable with the one or more pistons to controllably apply frictional force to the rotor.

15. The method of claim 14, wherein disposing a plurality of heat pipes within at least one of a rotor, a caliper and at least one a pair of brake pads comprises disposing evaporator ends of the heat pipes within the rotor and disposing condenser ends of the heat pipes within a rotor heat sink disposed within a center aperture of the wheel hub.

16. The method of claim 15 further including thermally connecting a rotor heat exchanger to the rotor heat sink.

17. The method of claim 14, wherein disposing a plurality of heat pipes within at least one of a rotor, a caliper and at least one a pair of brake pads comprises disposing evaporator ends of the heat pipes within the caliper and disposing condenser ends of the heat pipes within a caliper heat sink.

18. The method of claim 17 further including thermally connecting a caliper heat exchanger to the caliper heat sink.

19. The method of claim 14, wherein disposing a plurality of heat pipes within at least one of a rotor, a caliper and at least one a pair of brake pads comprises disposing evaporator ends of the heat pipes within at least one of the brake pads and disposing condenser ends of the heat pipes within at least one brake pad heat sink.

20. The method of claim 19 further including thermally connecting at least one brake pad heat exchanger to the at least one brake pad heat sink.
